(19) United States
(12) Patent Application Publication
(10) Pub. No.: US 2009/0103990 A1
(43) Pub. Date: Apr. 23, 2009

(54) Percussion-rotary drill

(75) Inventor: Olaf Koch, Kaufering (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/288,121

(22) Filed: Oct. 15, 2008

(30) Foreign Application Priority Data
Oct. 19, 2007 (DE) 10 2007 000 534.4

(51) Int. Cl. B26D 1/12

(52) U.S. Cl. 407/33

(57) ABSTRACT

A percussion-rotary drill includes a shaft (2) and a one-piece, hard material head (3, 3′, 3″) having two major cutting bits (4) each having a main cutting edge (5), and two minor cutting bits (6) each having a minor cutting edge (7) axially offset rearwardly along a rotational axis (A) of the drilling head (3, 3′, 3″) relative to an adjacent major cutting edge (5), with the two minor cutting bits (6) each having, in its radially outer region on both sides of the minor cutting edge (7), a tangential edge (8) extending at an angle thereto.

### BACKGROUND OF THE INVENTION

1. Field of the Invention

The present invention relates to a percussion-rotary drill having a one-piece, hard material drilling head for drilling concrete, stone, and brickwork.

2. Description of the Prior Art

Generally, contemporary, high-loaded, percussion-rotary drills for stone are provided, at the shaft end, with a compact, one-piece, hard material drilling head with two major cutting bits and two minor cutting bits. In addition to supporting the cutting function of the major cutting bit(s), the minor cutting bit(s) improve, in particular, the drill behavior upon encounting of a ductile reinforcing iron.

European Publication EP 1 604 793 discloses a percussion-rotary drill having a cross-shaped one-piece, hard material drilling head with two, arranged diametrically opposite each other, major cutting bits and two, arranged diametrically opposite each other minor cutting bits. The minor cutting bits each forms a minor cutting edge in form of a tangentially curved arcuate section offset axially rearwardly relative to the major cutting bit. The arcuate section is spaced from the rotational axis radially inwardly by an axial concave indentation and extends exactly radially outwardly in the radial direction.

European Publication EP 1 024 247 discloses a percussion-rotary drill with a hard material cutting plate inserted in a slot in the drilling head and having two, extending diametrically opposite each other major cutting bits. The major cutting bits each has, in its radially outer region, on the opposite sides, a tangential edge extending transverse thereto.

An object of the present invention is to further optimize a one-piece hard material drilling head for a percussion-rotary drill and, in particular, to improve its robustness when encountering an obliquely located reinforcement iron during drilling of bores.

### SUMMARY OF THE INVENTION

This and other objects of the present invention, which will become apparent hereinafter, are achieved by providing a percussion-rotary drill including a shaft, and a one-piece hard material head having two major cutting bits each having a main cutting edge, and two minor cutting bits each having a minor cutting edge axially offset rearwardly along a rotational axis of the drilling head relative to an adjacent cutting edge, with the two minor cutting bits each having in its radially outer region on both sides of the minor cutting edge, a tangential edge extending at an angle thereto.

The tangential edges, which are provided on the minor cutting bits and which extend at an angle toward the minor cutting edge, serve for displacing the percussion-rotary drill rearwardly upon bumping into a reinforcing iron, whereby the following the tangential edges, major cutting bits do not penetrate or penetrate to a very small extent in the ductile reinforcing iron and, thus, are subject only to a small load. Therefore, the possibility of a possible breaking-off of the radially outer corners of the main cutting bits upon encounter with a reinforcing iron is substantially reduced, which makes the percussion-rotary drill more robust.

Advantageously, the tangential edge and the adjacent minor cutting edge form an edge angle in a range from 50° to 85°, advantageously of 70°, which optimizes removal of both brittle stone and ductile reinforcing iron.

Advantageously, the major cutting bits are arranged diametrically opposite relative to each other and extend continuously over the drilling head diameter. Thereby, the substantial portion of the material removal job is carried out by the axially projecting main cutting bits on which the impact energy concentrated.

Advantageously, the major cutting edges form a drill tip, and two auxiliary cutting edges extend, respectively, from the drill tip in opposite direction exclusively in a radially inner region of the head at an angle toward the major cutting edge. This optimizes initial drilling into the material.

Advantageously, the minor cutting bits are arranged diametrically opposite each other and extend exclusively over a respective radial outer region of the drilling head, which permits to obtain the necessary symmetry.

Advantageously, the minor cutting bit has, in its radially central region, an axial concave indentation that, advantageously, extends to the tangential edge, whereby a tip is formed at the intersection.

Advantageously, the minor cutting edge is tangentially curved relative to an adjacent major cutting edge, forming, advantageously, a parabola. This improves the removal of drillings.

Advantageously, the major cutting edge and (the radially outer region of) minor cutting edge extend transverse to each other. Thereby, (with respect to the base surface, fourfold rotationally symmetrical), cross-shaped, one-piece, hard material drilling head is formed and which is adapted to a four-start drill helix, which is optimal for bore diameters in the range from 14 to 40 mm.

Alternatively, advantageously, the major cutting edge and (radially outer region of) the adjacent minor cutting edge form together a cutting edge angle (β) in a range from 20° to 45°. Thereby, a (with respect to the base surface, twofold rotationally symmetrical) flattened one-piece, hard material drilling head is formed, adapted for a two-start drill helix, which is optimal for bore diameters from 8 to 12 mm.

Advantageously, the one piece, hard material drilling head has an X-shape cross-section adapted to a two-start drill helix with minor helices, which is optimal for bore diameters in a range from 20 to 40 mm.

Alternatively, the one-piece, hard material drilling head has a rectangular cross-section adapted to a two-start drill helix without minor helices, which is optimal for bore diameters in a range from 8 to 18 mm.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a partial side view of a percussion-rotary drill according to the present invention;

FIG. 2 a plan view of the drill shown in FIG. 1;

FIG. 3 a plan view of another embodiment of a drilling head of a percussion-rotary drill according to the present invention; and

FIG. 4 a plan view of yet another embodiment of a drilling head of percussion-rotary drill according to the present invention.

### DETAILED DESCRIPTION OF THE PREFERRED EMBODIMENTS

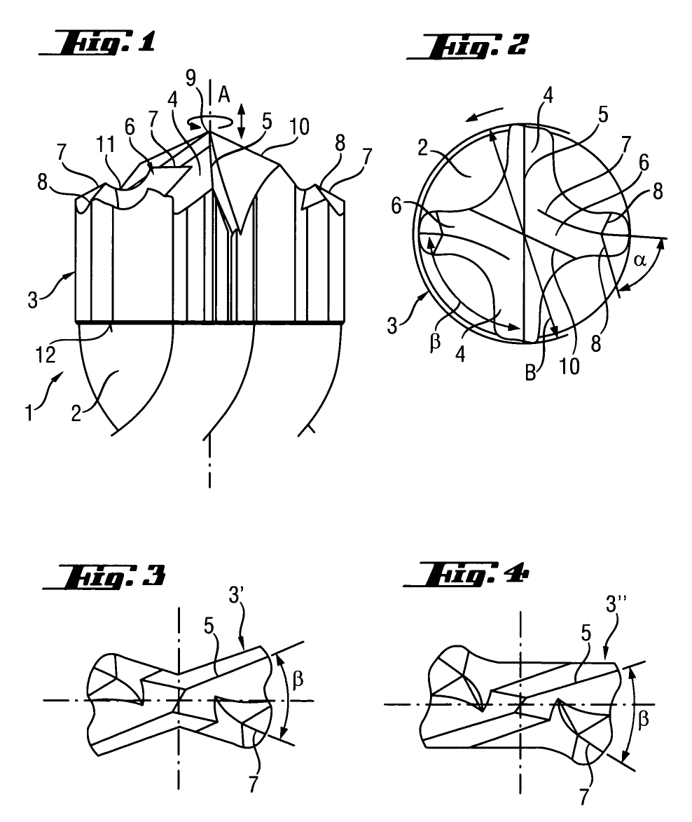

A percussion-rotary drill 1 according to the present invention, which is shown in FIG. 1, has a twist shaft 2 and a one-piece, hard-material drilling head 3 butt-welded with its base surface 12 to the shaft 2. The drilling head 3 has a tip 9 located on a rotational axis A of the drill 1, a major cutting bit 4 with a major cutting edge 5 extending from the tip 9, and two auxiliary cutting edges 11 located on opposite sides of the major cutting edge 5 and tangentionally inclined relative thereto. The auxiliary cutting edges 10 extend only over an inner radial half. Outside of the radial inner fifth of the rotational axis A, there is formed a minor cutting bit 6 having a minor cutting edge 7 that is offset rearwardly relative to the major cutting edge 5. The minor cutting bit 6 has, in its radially middle region, an axial concave indentation 11 that extends up to tangential edges 8.

According to FIG. 2, there are provided two main cutting bits 4 arranged diametrically relative to each other and extending continuously over the diameter B of the drilling head 3. The two, arranged diametrically opposite each other minor cutting bits 6 have, respectively, in their outer regions, on the opposite sides, two tangential edges 8, respectively, that extend, respectively, at an edge α of 70° relative to the radially outer minor cutting edge 7. In their radially inner region, the minor cutting edge 7 is curved tangentionally in form of a parabola to the adjacent major cutting edge 4. The major cutting edge 5 and the minor cutting edge in its outer radial region extend transverse to each other, whereby a rotationally symmetrical cross-shaped, one-piece, hard material drilling head 3 is formed with respect to its base surface 12 (FIG. 1).

According to FIGS. 3 and 4, the major cutting edge 5 and a radially outer region of the adjacent minor cutting edge 7 form together a cutting edge angle β of 30°, whereby, according to FIG. 3, a, with respect to the base surface, twofold, rotationally symmetrical, flattened, X-cross-sectional, one-piece, hard material drilling head 3′ is formed. According to FIG. 4, the one-piece, hard material, drilling head 3″ has a somewhat rectangular cross-section.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A percussion-rotary drill, comprising a shaft (2); and a one-piece, hard material head (3, 3′, 3″) having two major cutting bits (4) each having a main cutting edge (5), and two minor cutting bits (6) each having a minor cutting edge (7) axially offset rearwardly along a rotational axis (A) of the head (3, 3′, 3″) relative to an adjacent major cutting edge (5), the two minor cutting bits (6) each having, in a radially outer region thereof on both sides of the minor cutting edge (7), a tangential edge (8) extending at an angle thereto.

2. A percussion-rotary drill according to claim 1, wherein the tangential edge (8) and the adjacent minor cutting edge (7) form an edge angle (α) in a range from 50° to 85°.

3. A percussion-rotary drill according to claim 1, wherein the main cutting bits (4) are arranged diametrically opposite relative to each other and extend continuously over the head diameter (B)

4. A percussion-rotary drill according to claim 1, wherein the major cutting edges (5) form a drill tip (9), and two auxiliary cutting edges (10) extend, respectively, from the drip tip (9) in opposite direction exclusively in a radially inner region of the head (3, 3′, 3″) at an angle toward the major cutting bit (4).

5. A percussion-rotary drill according to claim 1, wherein the minor cutting bits (6) are arranged diametrically opposite each other and extend exclusively over a respective radial outer region of the head (3, 3′, 3″).

6. A percussion-rotary drill according to claim 1, wherein the minor cutting bit (6) has, in a radially central region thereof, an axial concave indentation (11).

7. A percussion-rotary drill according to claim 1, wherein the minor cutting edge (7) is tangentially curved relative to an adjacent major cutting bit (4).

8. A percussion-rotary drill according to claim 1, wherein the major cutting edge (5) and the minor cutting edge (7) extend transverse to each other.

9. A percussion-rotary drill according to claim 1, wherein the major cutting edge (5) and the adjacent minor cutting edge (7) form together a cutting edge angle (β) in a range from 20° to 45°.

10. A percussion-rotary drill according to claim 1, wherein the one-piece, hard material head (3′) has an X-shaped cross section.

11. A percussion-rotary drill according to claim 1, wherein the one-piece, hard material head (3″) has a substantially rectangular cross-section.
